(19) United States
(12) Patent Application Publication
(10) Pub. No.: US 2026/0064325 A1
(43) Pub. Date: Mar. 5, 2026

(54) NETWORK DEVICE, METHOD PERFORMED BY NETWORK DEVICE, AND STORAGE MEDIUM

(71) Applicant: CANON KABUSHIKI KAISHA, Tokyo (JP)

(72) Inventor: YOSHINOBU HAMADA, Kanagawa (JP)

(21) Appl. No.: 19/308,508

(22) Filed: Aug. 25, 2025

(30) Foreign Application Priority Data
Sep. 3, 2024 (JP) 2024-151355

(51) Int. Cl. G06F 3/12; H04N 1/00

(52) U.S. Cl. CPC G06F 3/1205; G06F 3/123; G06F 3/1253; G06F 3/1288; H04N 1/00244; H04N 1/00464; H04N 1/00477; H04N 1/00482; H04N 1/00973; H04N 2201/0094

(57) ABSTRACT

A network device provides a web browser with a setting screen for operating setting values of a plurality of setting items using the web server and reflects the setting values in the network device in response to an operation of the setting values. The network device provides a web site for installing software that is a progressive web app for providing a function of operating setting values of at least one setting item among the plurality of setting items in a user terminal by the web server. The network device reflects at least one setting value in response to reception of detail of the operation at least one of the setting values performed using the progressive web app from the user terminal regardless of whether the setting screen has been provided.

### BACKGROUND

### Field

The present disclosure relates to technology of information processing in a network device.

### Description of the Related Art

A network device such as an image forming apparatus is provided with a function (hereinafter referred to as a remote UI) of allowing a user to access the network device via a network using a terminal and to perform ascertainment of an operation situation of the network device, various types of settings, and the like. A user can use the remote UI by accessing a predetermined URL of a web server operating in the network device using a web browser having an RSS function or the like.

Japanese Unexamined Patent Publication No. 2010-267032 discloses a technique of providing a user who has made a request to acquire information on error occurrence or a job status with the job status of only a print job executed by the user out of all print jobs using a remote UI provided by an image forming apparatus.

A manager or a general user of a network device can change settings of the network device or the like using the remote UI. However, for example, when communication with a network device is not possible such as when the network device is not powered on, the remote UI cannot be used. Accordingly, the manager or the general user cannot change the settings when it is intended to change the settings and has to wait until the network device is operating, open a setting change screen, and perform the setting again using the remote UI.

### SUMMARY

The present disclosure provides a technique capable of appropriately setting a network device regardless of a state of the network device.

A network device including a web server according to an aspect of the present disclosure comprises: a memory storing instructions; and a processor executing the stored instructions causing the network device to: provide a web browser with a setting screen for adjusting setting values of a plurality of setting items for the network device via a network using the web server; and reflect the setting values in the network device in response to an operation of the setting values. A web site for installing software that is a progressive web app for providing a function of operating setting values of at least one setting item among the plurality of setting items in a user terminal is provided by the web server. at least one setting value is reflected in the network device in response to reception of detail of the operation of at least one of the setting values performed using the progressive web app from the user terminal via the network regardless of whether the setting screen has been provided by the network device.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a system.

FIG. 2 is a block diagram illustrating an example of hardware configurations of devices constituting the system.

FIG. 3 is a block diagram illustrating an example of a software module configuration of an MFP.

FIG. 4 is a block diagram illustrating an example of a software module configuration of a push server.

FIG. 5 is a block diagram illustrating an example of a software module configuration of a web browser.

FIG. 6 is a sequence diagram illustrating processes at the time of installation of a PWA.

FIG. 7 is a diagram illustrating an example of a screen that is displayed by the web browser.

FIG. 8 is a diagram illustrating an example of a screen of a remote UI when the screen illustrated in FIG. 7 is displayed by the PWA.

FIG. 9 is a diagram illustrating an example of a screen for requesting reception of a push notification that is displayed by the PWA.

FIG. 10 is a sequence diagram illustrating processes of changing settings of an MFP according to a first embodiment.

FIG. 11 is a sequence diagram illustrating processes subsequent to FIG. 10.

FIG. 12 is a diagram illustrating an example of a setting change screen that is displayed by the PWA in S804.

FIG. 13 is a diagram illustrating an example of a screen that is displayed by the PWA in S807.

FIG. 14 is a diagram illustrating an example of setting change details that are stored in the PWA in S805.

FIG. 15A is a diagram illustrating an example of a notification indicating that the setting change received in S804 has been performed and completed by the MFP, and FIG. 15B is a diagram illustrating an example of a notification that is displayed in S832.

FIG. 16A is a diagram illustrating an example of a restart screen that is displayed in S834, FIG. 16B is a diagram illustrating an example of a restart screen including an ascertainment dialog that is displayed in S836 and FIG. 16C is a diagram illustrating an example of a restart screen that is displayed in S841.

FIG. 17 is a sequence diagram illustrating processes of changing settings of an MFP according to a second embodiment.

FIG. 18 is a sequence diagram illustrating processes when the MFP is powered on.

FIG. 19 is a sequence diagram illustrating processes when details of an operation setting correspond to pattern 1.

FIG. 20 is a sequence diagram illustrating processes when details of an operation setting correspond to pattern 3.

FIG. 21 is a diagram illustrating an example of an operation setting screen when the MFP is powered on.

FIG. 22A is a diagram illustrating an example of a notification indicating that the MFP is powered on, and FIG. 22B is a diagram illustrating an example of a notification indicating that restart of the MFP for reflecting setting change has been completed.

FIG. 23 is a sequence diagram illustrating processes when a web browser is started according to a third embodiment.

FIG. 24 is a sequence diagram illustrating processes that are started when communication with an MFP is not possible in S806 according to a fourth embodiment.

### DESCRIPTION OF THE EMBODIMENTS

Hereinafter, embodiments of the present disclosure will be described with reference to the accompanying drawings. All of a plurality of features in the embodiments of the present disclosure are not essential, and a plurality of features may be arbitrarily combined. Configurations described in the following embodiments are merely examples, and the present disclosure is not limited to the illustrated configurations. The same or similar constituents in the drawings will be referred to by the same reference signs, and repeated description thereof will be omitted.

### First Embodiment

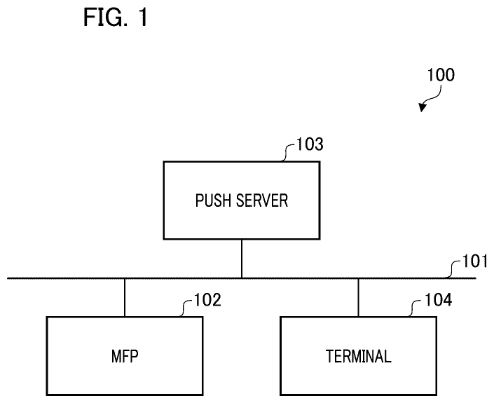

FIG. 1 is a diagram illustrating an example of a system configuration of a system 100 according to an embodiment of the present disclosure. The system 100 includes a multi-functional peripheral (MFP) 102, a push server 103, and a terminal 104. The MFP 102, the push server 103, and the terminal 104 are connected to a network 101.

A network is, for example, a communication network that is realized by any one of a LAN, a WAN, a telephone line, a dedicated digital line, an ATM, a frame relay line, a cable television line, and a data-broadcast wireless line or a combination of two or more thereof. The LAN may be constructed in a company.

The MFP 102 is a multi-function peripheral (MFP) which is a kind of a network device and has a function of a remote UI. The push server 103 is a server that is prepared for a vendor of a web browser or the like to provide a push notification service via the web browser. The terminal 104 is an electronic device that is used in business or the like by a user who manages or uses the MFP 102. The terminal 104 is, for example, a tablet, a smartphone, or a PC. A user of the terminal 104 can use the remote UI of the MFP 102 via a web browser which operates in the terminal 104.

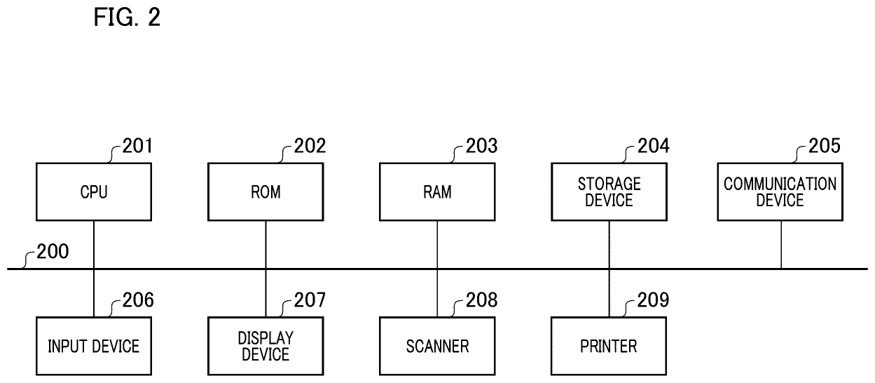

FIG. 2 is a block diagram illustrating an example of hardware configurations of the MFP 102, the push server 103, and the terminal 104. A scanner 208 and a printer 209 out of these blocks are devices that are mainly included in the MFP 102.

A CPU 201 comprehensively controls hardware as a whole and controls constituents connected to a bus 200, for example, such that various functions such as printing and scanning are performed. A ROM 202 is a memory dedicated for reading data and stores a basic control program of the MFP 102, for example, in the case of the MFP 102. A RAM 203 is a memory in which reading/writing of data is possible and is used, for example, as a working memory of the CPU 201.

A programmable logic device (PLD) such as a field-programmable gate array (FPGA) may be used instead of the CPU 201. Alternatively, an application-specific integrated circuit (ASIC) may be used or a digital signal processor (DSP) may be used.

A storage device 204 is an HDD, an SSD, or the like and is used as a storage area of programs that are executed by the CPU 201 or data that is used for the programs. In the case of the MFP 102, the storage device 204 is also used as a storage area of an image to be printed or scanned. The storage device 204 may be a device that can read/write data with respect to an external medium such as a CD, a DVD, or a memory card attached thereto.

A communication device 205 is connected to the network 101 and enables network communication with another device or service. In the MFP 102, the communication device 205 also receives printing data or scanning data transmitted from the terminal 104.

An input device 206 is an operation unit that receives an input operation of text or data from a user. The input device 206 includes, for example, a keyboard, a mouse, hardware keys, and a touch panel.

A display device 207 is a device that displays various screens and is, for example a liquid crystal display or a touch panel. A user can input an instruction to a screen of a user interface (UI) displayed on the display device 207 via the input device 206 and perform instructing to perform an operation, setting, or the like on the MFP 102. The input device 206 and the display device 207 may be unified using a touch panel.

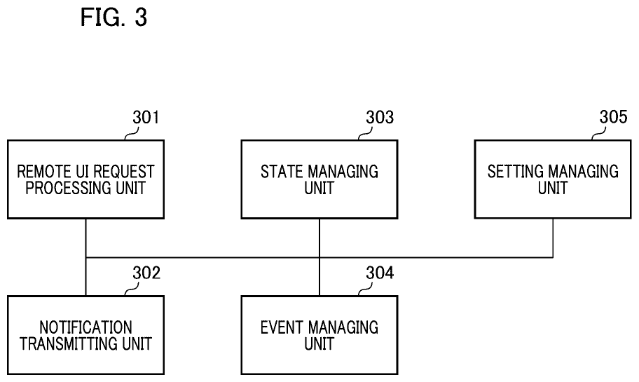

FIG. 3 is a diagram illustrating an example of a configuration of software modules of the MFP 102. The software configuration illustrated in FIG. 3 is realized, for example, by causing the CPU 201 to read a program stored in the ROM 202 into the RAM 203 and to execute the program.

A remote UI request processing unit 301 receives a request from a web browser 500 which will be described later of the terminal 104 and provides a menu screen for managing the MFP 102 or information for displaying state information or the like of the MFP 102 acquired from a state managing unit 303 which will be described later. The remote UI request processing unit 301 performs the requested setting change. The remote UI request processing unit 301 is mainly an example of a provision means for providing a setting screen for operating setting values of a plurality of setting items for the network device to the web browser via the network.

In changing settings of the MFP 102 according to the present embodiment, restart of the MFP 102 may be required or may not be required for reflection of the change according to setting details. This is because, when restart is required for reflection of changes of all the settings, the MFP 102 may cause hindrance of its operation or the like by reflecting the setting change while operating.

A notification transmitting unit 302 receives a request for a push notification from an event managing unit 304 which will be described later and issues a push notification to the terminal 104 which is a notification target registered in advance. When a request for a push notification is received from the event managing unit 304, the notification transmitting unit 302 edits details of the request into a format for a request to the push server 103 and transmits the edited details to the push server 103. The notification transmitting unit 302 is an example of a notification means for transmitting a push notification corresponding to an event occurring in the network device to the user terminal via the network.

A state managing unit 303 performs printing control, abnormality management, and the like of the MFP 102 and also performs management of counter information or management of notification information. The counter information includes, for example, the number of printed sheets, degrees of consumption of components, and residual amounts of consumables such as a toner bottle in the MFP 102.

An event managing unit 304 receives an event occurring in the MFP 102 and manages event information. The event information managed by the event managing unit 304 includes powering-on/off of the MFP 102, an event of a printing job issued by a user, and an error (which may be referred to as an obstacle). Examples of the error in the MFP 102 include an error with high emergency such as a hard disk error or an error with a warning level such as paper jam or toner low. Event information indicating replacement of a toner bottle, firmware update, and the like are also managed. The event managing unit 304 detects occurrence of an event and transmits a request for a push notification corresponding to the detected event to the notification transmitting unit 302 according to necessity.

A setting managing unit 305 manages various settings of the MFP 102 and performs a response or change of various types of setting information in response to a request from the remote UI request processing unit 301 or an operation on the input device 206. The setting managing unit 305 receives a request from the remote UI request processing unit 301 and also takes charge of a process of restarting the MFP 102. The setting managing unit 305 is an example of a reflection means for reflecting operated setting values in the network device in response to an operation of setting values. The setting managing unit 305 is an example of a processing means for starting the process of restarting the network device.

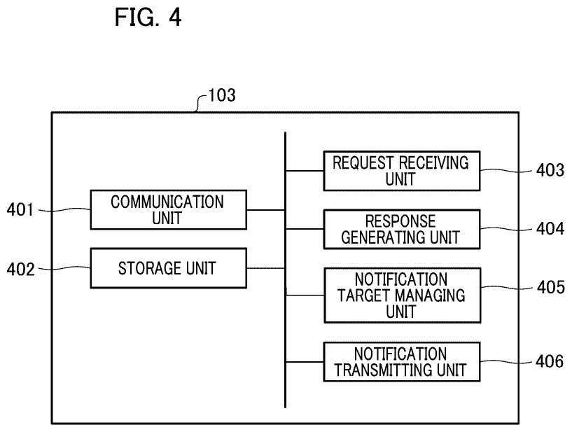

FIG. 4 is a diagram illustrating an example of a software module configuration of the push server 103. The push server 103 includes a communication unit 401, a storage unit 402, a request receiving unit 403, a response generating unit 404, a notification target managing unit 405, and a notification transmitting unit 406.

The communication unit 401 has a function of communicating with the MFP 102 or the terminal 104. Specifically, the communication unit 401 performs reception of a push notification transmitted from the MFP 102 or transmission of a push notification request to the web browser 500 operating in the terminal 104 which will be described later.

The storage unit 402 performs storage control of information on the RAM 203, the ROM 202, and the storage device 204. In the present embodiment, a target of storage control includes information of a target terminal of a push notification and information of a push notification request.

The request receiving unit 403 receives a request for registration as a target of a push notification transmitted from the web browser 500 operating in the terminal 104 or a push notification request from the notification transmitting unit 302.

The response generating unit 404 transmits a push subscription object which will be described later to the web browser 500 which is a request source as a response to the request for registration as a target of a push notification.

The notification target managing unit 405 manages information of a terminal registered as a target of a push notification. The information of a terminal registered as a target of a push notification includes an identifier for identifying a target terminal and a push subscription object. In the present embodiment, the terminal 104 is registered as a target of a push notification.

The notification transmitting unit 406 transmits a push notification request to a notification target terminal on the basis of end point information included in the push notification request received from the notification transmitting unit 302. The notification may include a notification such as information of an error occurring in the MFP 102, information of degrees of consumables, or information from a manager in addition to a notification indicating that the MFP 102 according to the present embodiment is powered on.

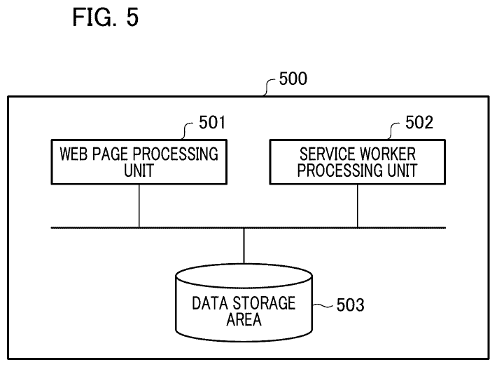

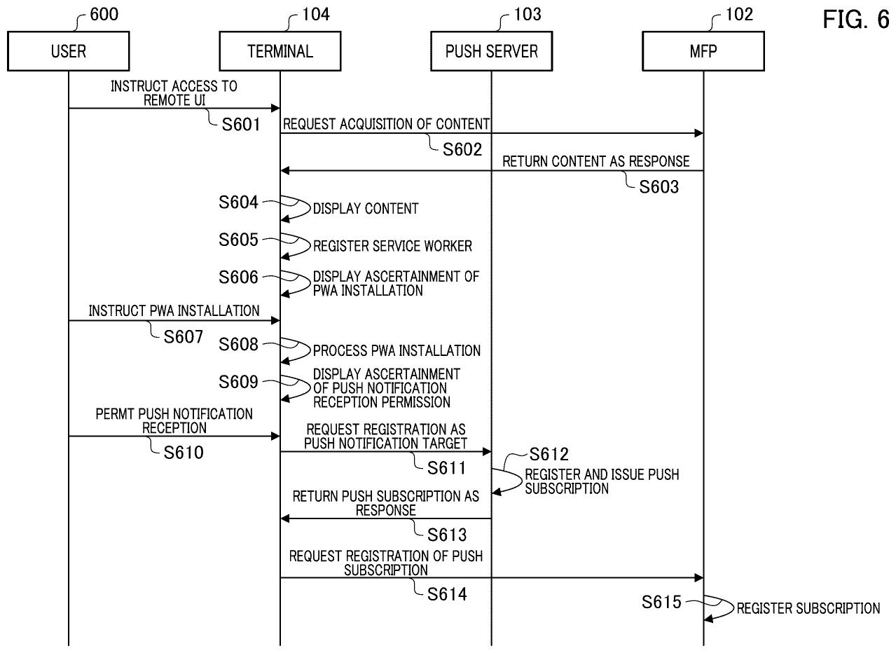

FIG. 5 is a block diagram illustrating an example of a software configuration of the web browser 500 operating in the terminal 104. The software configuration illustrated in FIG. 5 is realized, for example, by causing the CPU 201 to read a program stored in the ROM 202 or the storage device 204 into the RAM 203 and to execute the program.

It is assumed that the web browser 500 according to the present embodiment corresponds to a progressive web app (hereinafter referred to as a PWA). PWA is a technique of enabling a web site to be used like a native app and is a kind of application. The PWA is a (web) application having at least some functions of functions which can be provided via a network by the MFP 102 or functions which can be provided from a remote UI. The MFP 102 provides a remote UI to a web browser having accessed an address (URL, IP addresses, or the like) assigned to the remote UI thereof. A user can install the PWA for the MFP 102 according to the present embodiment in the terminal 104 via the remote UI. A user does not have to access an app store like a native app in the related art and download the PWA, and a user can simply install and use a web site via the web browser when the user accesses the web site providing the PWA. Similarly to a native app, an icon for using the PWA may be able to be added to a desktop, a home screen, or the like of the terminal 104.

A web page processing unit 501 performs processing such as communication with the remote UI request processing unit 301 of the MFP 102 or display of web content received from the remote UI request processing unit 301 in accordance with an instruction received from a user of the terminal 104. The web content is described, for example, in Hyper Text Markup Language (HTML), JavaScript, or Cascading Style Sheets (CSS). The web content includes a service worker (a script operating as a background process) which is an element of the PWA or a manifest file (a file in which installation settings of the PWA are described).

A service worker processing unit 502 executes a service worker which is an element of the PWA received from the remote UI request processing unit 301 of the MFP 102.

A data storage area 503 is an area that temporarily or permanently stores data such as web content received from the remote UI request processing unit 301 of the MFP 102 or details of an instruction received from a user of the terminal 104. Specifically, the data storage area 503 is provided in the RAM 203 or the storage device 204 of the terminal 104. The web page processing unit 501 and the service worker processing unit 502 perform processing appropriately using the data storage area 503.

FIG. 6 is a diagram illustrating a sequence until a PWA is installed in the terminal 104 from the MFP 102 and can receive a push notification from the MFP 102. In FIG. 6, it is assumed that a user 600 is a user of the terminal 104 and changes settings of the MFP 102 via the terminal 104.

Out of various processes illustrated in FIG. 6, processes performed by the MFP 102 are realized by causing the CPU 201 of the MFP 102 to read a program of the software modules illustrated in FIG. 3 and stored in the storage device 204 to the RAM 203 and to execute the read program. The processes performed by the server 103 are realized by causing the CPU 201 of the push server 103 to read a program of the software modules illustrated in FIG. 4 and stored in the storage device 204 to the RAM 203 and to execute the read program. Similarly, the steps performed by the terminal 104 are realized by causing the CPU 201 of the terminal 104 to read a program of the software modules illustrated in FIG. 5 and stored in the storage device 204 to the RAM 203 and to execute the read program.

In S601, the user 600 instructs the web browser 500 operating in the terminal 104 of the user 600 to access the remote UI of the MFP 102. Specifically, the user 600 instructs to access the remote UI of the MFP 102 by inputting address information assigned to the remote UI in the MFP 102 to an address bar of the web browser 500.

In S602, the web page processing unit 501 of the web browser 500 executed in the terminal 104 requests the remote UI request processing unit 301 of the MFP 102 to transmits web content of the remote UI on the basis of the address information input in S601.

In S603, the remote UI request processing unit 301 of the MFP 102 returns the requested web content as a response. The web content which is returned here includes a manifest file or a service worker for installing and executing a remote UI as a PWA in addition to screen information of the remote UI displayed on the web browser 500.

In S604, the web page processing unit 501 of the terminal 104 analyzes details of the web content acquired in S603 and displays a screen of the remote UI on the web browser 500.

In S605, the web page processing unit 501 of the terminal 104 registers the service worker included in the web content acquired in S603 in the data storage area 503. The service worker which is registered here is a script for defining a push notification function which is a feature of the PWA or behavior such as an off-line operation and is executed in the background by the service worker processing unit 502. That is, while a user does not access the remote UI via the web browser, a push notification to the installed PWA or the like is realized via the service worker operating in the background by the service worker processing unit 502.

Instructions associated with cache control may be described in the service worker. In this case, the service worker processing unit 502 stores the web content acquired in S603 as cache in the data storage area 503 according to description details thereof at the time of registration.

In S606, the web page processing unit 501 of the terminal 104 displays a screen for prompting a user to install a PWA on the web browser 500 on the basis of the manifest file included in the web content acquired in S603.

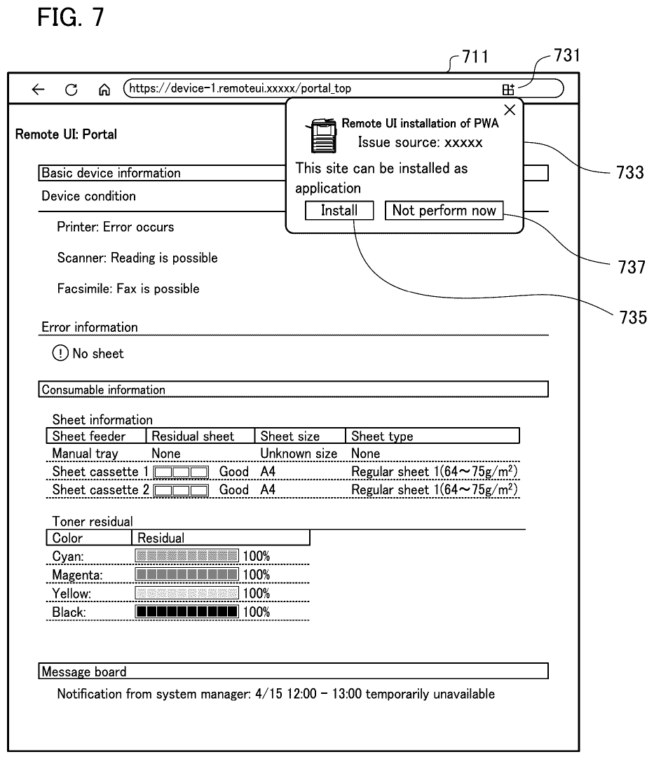

FIG. 7 is a diagram illustrating an example of a screen 711 that is displayed on the web browser 500 in S606. A button 731 is displayed when a manifest file is included in the web content. A dialog 733 is displayed to allow the user 600 to ascertain whether to install the PWA. In the present embodiment, when a manifest file is included in the web content, the dialog 733 is automatically display. However, the dialog 733 may be displayed in response to pressing of the button 731 by the user 600.

A button 735 is a button that is pressed by the user 600 when the PWA is installed. A button 737 is a button that is pressed by the user 600 when the PWA is not installed. In the present embodiment, a case in which the user 600 presses the button 735 to start installation of the PWA will be described.

In S607, the user 600 presses the button 735 and instructs the web browser 500 operating in the terminal 104 to install the PWA.

In S608, the web page processing unit 501 of the terminal 104 installs the web content of the remote UI acquired in S603 as the PWA on the basis of details of the manifest file. In the following description, the PWA executed in the web browser 500 is described to be an operation subject in the terminal 104. The web page processing unit 501 may generate an icon for starting the PWA on a desktop, a home screen, or the like of the terminal 104 at the time of installation of the PWA.

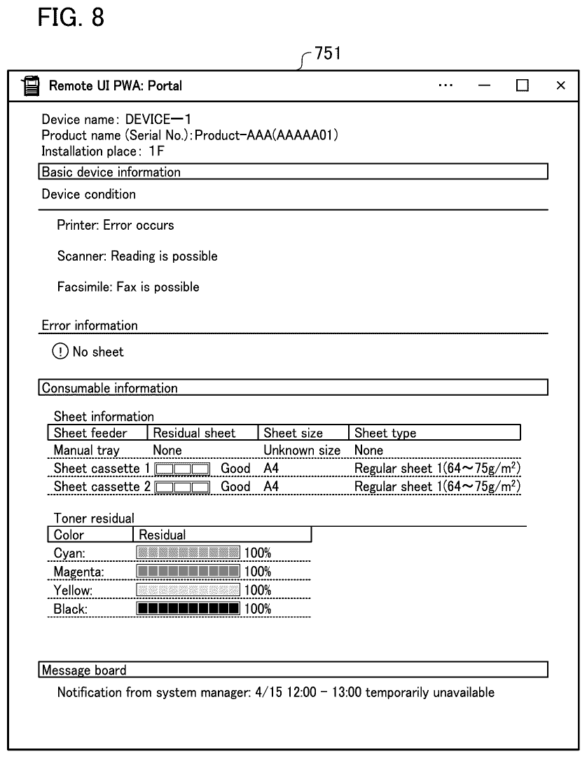

FIG. 8 is a diagram illustrating an example of a screen of the remote UI that is displayed by the PWA when the PWA has been installed. Display details of a screen 751 illustrated in FIG. 8 are the same as displayed on the screen 711 illustrated in FIG. 7 and are displayed as if a native app were operated unlike display on a normal web browser, for example, such that an address bar is not displayed. When the user 600 starts the installed PWA, the screen 751 illustrated in FIG. 8 is displayed on the web browser 500.

In S609, the PWA operating in the terminal 104 displays a message for requesting the user 600 to permit receiving a push notification.

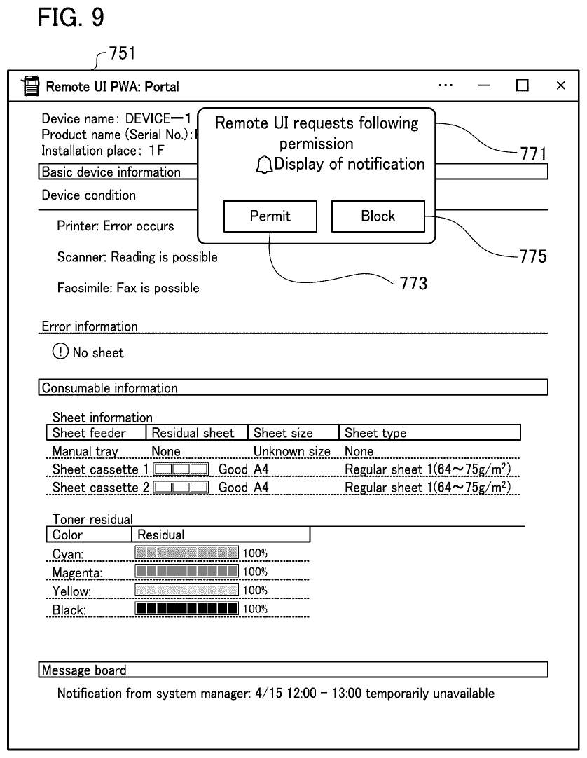

FIG. 9 is a diagram illustrating an example of a screen for requesting for permission of receiving a push notification displayed by the PWA in S609. In FIG. 9, a dialog 771 is displayed to request the user 600 to permit receiving a push notification. When receiving of a push notification is permitted, the user 600 presses a permission button 773. When receiving of a push notification is not permitted, the user 600 presses a block button 775. In the present embodiment, a case in which the user 600 presses the permission button 773 to permit receiving a push notification will be described.

In S610, the user 600 presses the permission button 773 and instructs the web browser 500 to permit receiving a push notification.

In S611, the web browser 500 transmits a request for requesting the push server 103 to register the PWA operating in the terminal 104 as a target of a push notification. In S612, when the request in the S661 is received, the request receiving unit 403 of the push server 103 transmits details thereof to the notification target managing unit 405. Then, the notification target managing unit 405 registers the PWA operating in the terminal 104 as a target of a push notification and issues a push subscription object. The push subscription object includes information which is used to correlate a transmitter and a receiver of a push notification and which is required when the notification transmitting unit 302 of the MFP 102 which will be described later transmits a push notification to the PWA operating in the terminal 104. Specifically, the push subscription object includes end point information of the push server 103 including a URL of the push server 103 and end point text varying according to a target of a push notification.

In S613, the response generating unit 404 of the push server 103 transmits the push subscription object issued in S612 to the PWA which is a request source as a response to the request received in S611.

In S614, the PWA transmits the received push subscription object to the remote UI request processing unit 301 of the MFP 102.

In S615, the remote UI request processing unit 301 of the MFP 102 registers the received push subscription object in the notification transmitting unit 302. The push subscription object registered herein is used for the notification transmitting unit 302 of the MFP 102 to request the push server 103 to transmit a push notification for the terminal 104 to be notified.

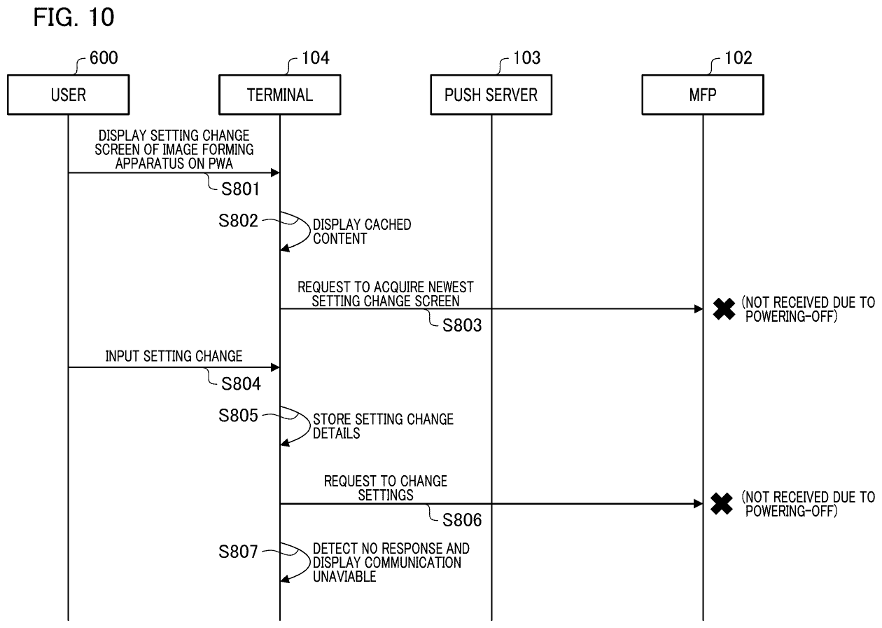

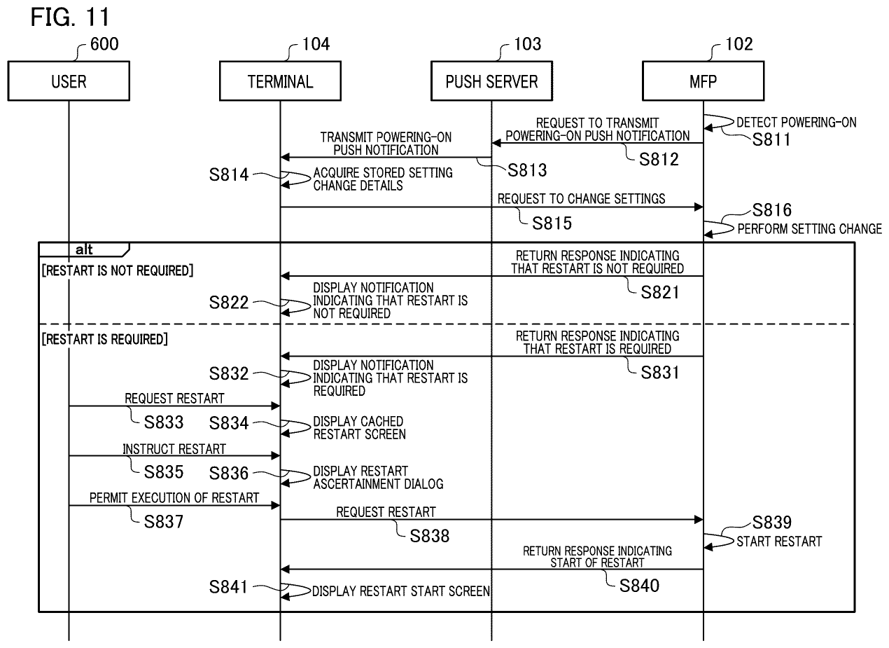

A sequence of processes when the user 600 changes settings of the MFP 102 via the PWA when the MFP 102 is powered off will be described below with reference to FIGS. 10 and 11. Out of various processes illustrated in FIGS. 10 and 11, the processes performed by the MFP 102 are realized by causing the CPU 201 of the MFP 102 to read a program of the software modules illustrated in FIG. 3 and stored in the storage device 204 to the RAM 203 and to execute the read program. The processes performed by the push server 103 are realized by causing the CPU 201 of the push server 103 to read a program of the software modules illustrated in FIG. 4 and stored in the storage device 204 to the RAM 203 and to execute the read program. Similarly, the processes performed by the constituent devices of the terminal 104 are realized by causing the CPU 201 of the terminal 104 to read a program of the software modules illustrated in FIG. 5 and stored in the storage device 204 to the RAM 203 and to execute the read program.

In S801, the user 600 instructs the PWA operating in the terminal 104 to display, for example, a setting change screen for changing settings of the MFP 102.

In S802, the PWA displays the setting change screen using information of content stored in the data storage area 503 before communicating with the MFP 102. This operation is for enhancing responsiveness to a display request from the user 600.

In S803, the PWA requests the MFP 102 to acquire a newest setting change screen. When the MFP 102 operates normally, this request is received and answered by the remote UI request processing unit 301. However, in this example, since the MFP 102 is powered off, the request is not received and is not answered.

In S804, the user 600 inputs setting change on the setting change screen displayed by the PWA.

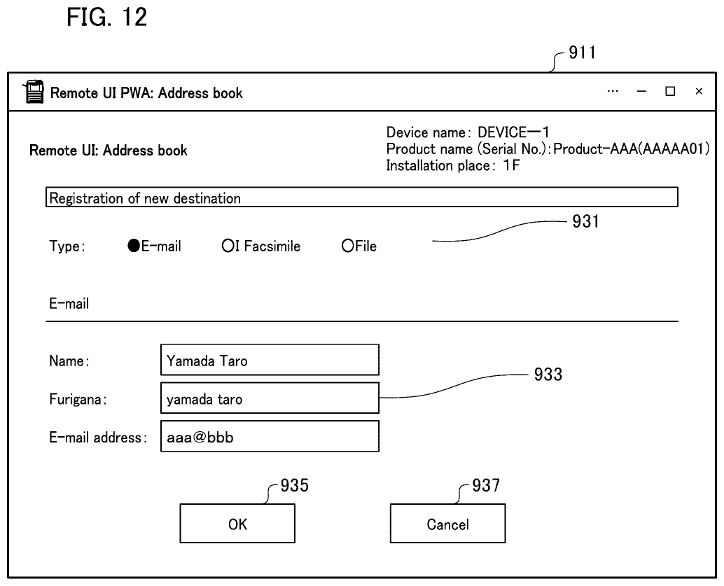

FIG. 12 is a diagram illustrating an example of the setting change screen that is displayed by the PWA in S804. A setting change screen 911 illustrated in FIG. 12 is a screen for registering settings of a destination in a function of transmitting a scanned image which is provided in the MFP 102. The setting change screen 911 is an example of a setting screen including a plurality of setting items for operating setting values. A type selection object 931 is a radio button group for selecting a transmission method. For example, E-mail, I-facsimile, or file can be selected. An input form object 933 is an input field for inputting a name or an address of a destination or the like. An OK button 935 is a button for confirming selection and inputting performed on the setting change screen 911 and transmitting a setting change request to the MFP 102. A cancel button 937 is a button for discarding selected and input information and returning to a screen before transitioning to the setting change screen 911. In this description, it is assumed that the user 600 performs selection and inputting on the setting change screen 911 and the OK button 935 is pressed.

The setting change screen of an address book illustrated in FIG. 12 is only an example as a setting screen for operating the setting values of the MFP 102. The setting screen additionally includes environment setting or application setting of the MFP 102. Address book setting is one type of application setting.

In S805, the PWA operating in the terminal 104 stores details of the input setting change in the data storage area 503.

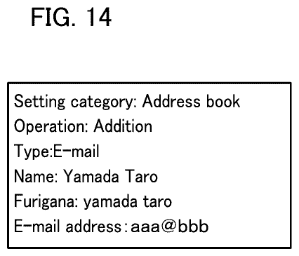

FIG. 14 is a diagram illustrating an example of details of setting change stored in the PWA in S805. A “setting category” indicates a setting object in the MFP 102. An “operation” indicates whether what change is to be performed (for example, addition, change, or deletion) and indicates operation details indicating that a destination is added to the address book herein. A “type,” a “name,” and the like are setting items of the address book and are details selected or input via the setting change screen 911.

In S806, the PWA requests the MFP 102 to change settings. When the MFP 102 operates normally, this request is received by the remote UI request processing unit 301 and the setting change is performed. However, in this example, since the MFP 102 is powered off, the request is not received and the setting change is not performed.

In S807, the PWA detects that there is no response to the request in S806 due to timeout or the like and displays a message indicating that communication with the MFP 102 is not possible.

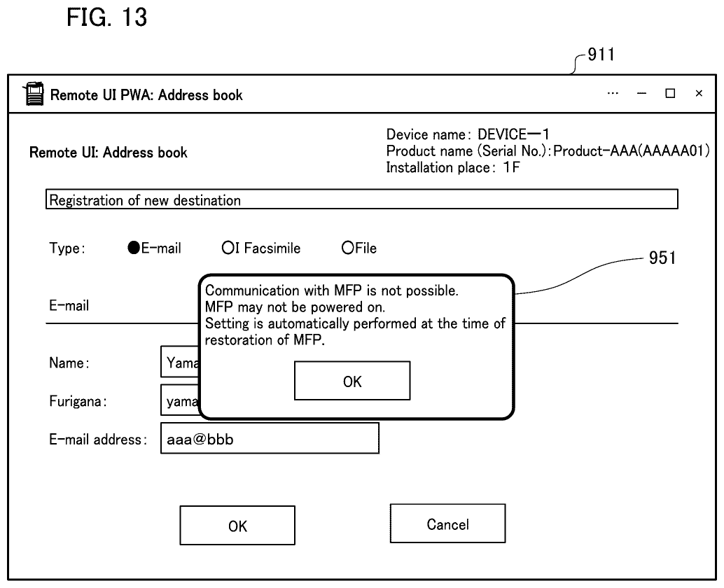

FIG. 13 is a diagram illustrating an example of a screen that is displayed by the PWA in S807. In FIG. 13, a dialog 951 is an area in which a message indicating that communication with the MFP 102 is not possible is displayed. As illustrated in the drawing, the dialog 951 can also display a message indicating that setting is automatically performed when communication with the MFP 102 is restored.

FIG. 11 is a diagram illustrating a sequence of processes when the MFP 102 is powered on after S806. FIG. 11 strictly illustrates a sequence when the software modules of the MFP 102 illustrated in FIG. 3 operate after the MFP 102 has been powered on. In the present embodiment, this state is expressed as powering-on.

In S811, the event managing unit 304 of the MFP 102 detects powering-on as an event in the MFP 102 and requests the notification transmitting unit 302 to transmit a push notification of the powering-on event.

In S812, the notification transmitting unit 302 transmits a push notification request for notifying the registered terminal 104 to be notified that the MFP 102 has been powered on to the push server 103.

In S813, the request receiving unit 403 of the push server 103 receives the push notification request of S812 and sends details thereof to the notification transmitting unit 406. The notification transmitting unit 406 transmits a push notification indicating that the MFP 102 has been powered on to the terminal 104 to be notified on the basis of information included in the push notification request.

In S814, when the push notification in S813 is received, the PWA operating in the terminal 104 acquires setting change details stored in the data storage area 503 in S805. In the present embodiment, the PWA does not display a notification corresponding to the received push notification, but may display the notification to notify the user 600 that the MFP 102 has been powered on.

In S814, the PWA ascertains whether setting change details are stored in the data storage area 503. In the present embodiment, it is assumed that setting change details are stored in S805 and setting change details are stored in the data storage area 503.

In S815, the PWA requests setting change in the MFP 102 on the basis of the setting change details acquired in S814.

In S816, the remote UI request processing unit 301 of the MFP 102 receives the setting change request in S815 and performs the setting change based on details of the request on the setting managing unit 305.

Regarding subsequent processes, cases in which restart of the MFP 102 is required or not required to actually reflect the change will be described. This is because settings are reflected through the processes up to now when restart is not required and the setting change is half-finished and not reflected when restart is required, which is to be avoided.

A sequence when the setting change performed in S816 does not require restart of the MFP 102 will be first described. In S821, the remote UI request processing unit 301 returns a response indicating that the setting change has been completed and restart is not required as a response to the setting change request in S815.

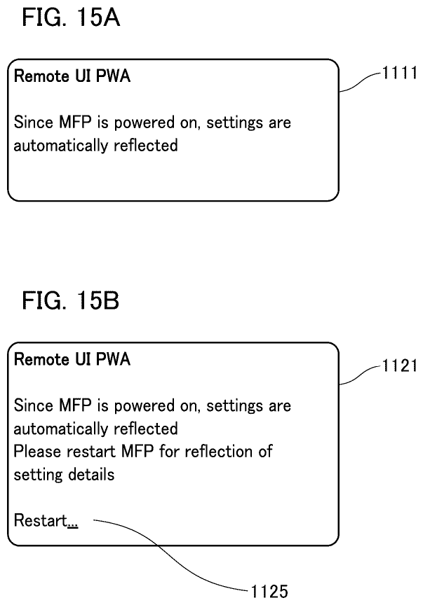

In S822, the PWA operating in the terminal 104 receives the response in S821 and displays a notification indicating that the setting change received in S804 has been performed and completed by the MFP 102 on the terminal 104 via the web browser 500. FIG. 15A illustrates an example of a notification 1111 which is displayed at that time.

A sequence when the setting change performed in S816 requires restart of the MFP 102 will be then described. In S831, the remote UI request processing unit 301 returns a response indicating that restart is required for completion of the setting change as a response to the setting change request in S815.

In S832, the PWA operating in the terminal 104 receives the response in S831 and displays a notification indicating that the setting change received in S804 has been performed in the MFP 102 and a notification indicating that restart of the MFP 102 is required for reflection of the change. FIG. 15B illustrates an example of a notification 1121 which is displayed in S832. In FIG. 15B, a link 1125 is a link for displaying a restart screen for restarting the MFP 102 which will be described later.

In S833, the user 600 receives the notification displayed in S832 and presses, for example, the link 1125 of the notification 1121 to instruct the PWA to display a restart screen for restarting the MFP 102 which will be described later.

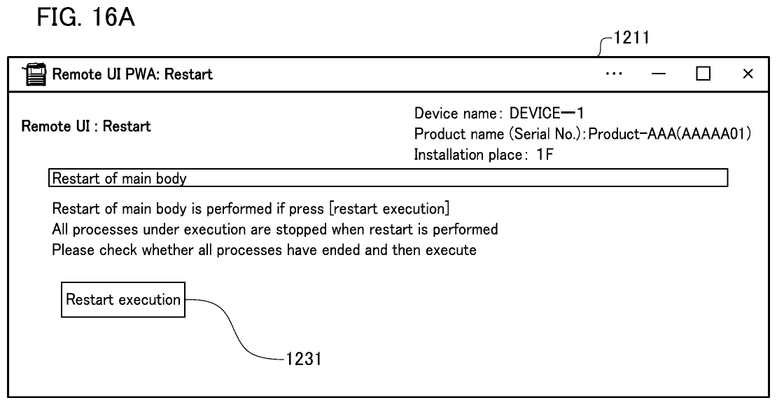

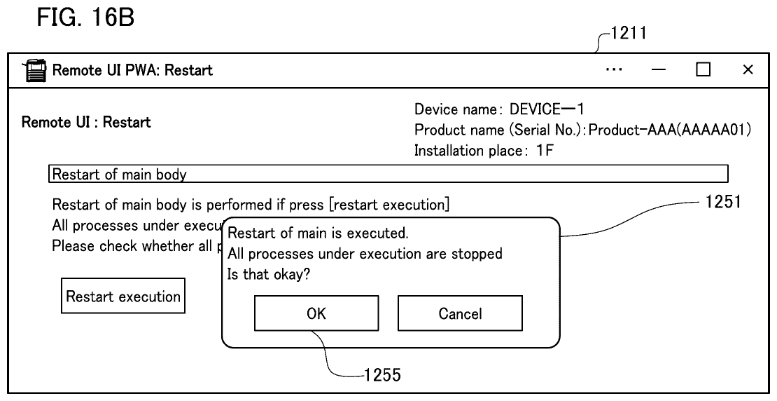

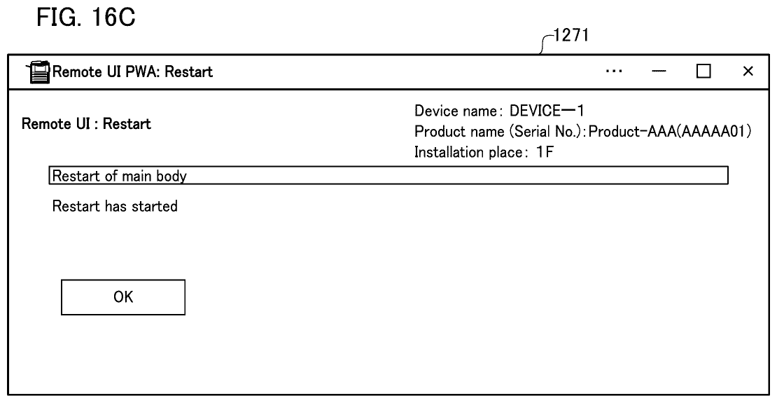

In S834, the PWA displays a restart screen 1211 (FIG. 16A) using information stored in the data storage area 503 in response to the instruction in S833. When information of the restart screen is not stored in the data storage area 503, it is assumed that the PWA communicates with the MFP 102 and acquires and displays information of the restart screen.

FIG. 16A illustrates an example of the restart screen 1211 displayed in S834. A restart execution button 1231 is a button for receiving a restart instruction from the user 600.

In S835, the user 600 presses the restart execution button 1231 of the restart screen 1211 displayed in S834 and instructs to restart the MFP 102.

In S836, the PWA receives the instruction in S835 and displays an ascertainment dialog for inquiring of the user 600 about whether the MFP 102 is to be actually restarted.

FIG. 16B illustrates an example of the restart screen 1211 including the ascertainment dialog 1251 displayed in S836. An OK button 1255 is a button for receiving permission of restart execution from the user 600.

In S837, the user 600 presses the OK button 1255 of the ascertainment dialog 1251 displayed in S836 and permits restart of the MFP 102.

In S838, the PWA receives the permission of S837 and requests the MFP 102 to restart. In S839, the MFP 102 starts a process of restarting the MFP 102. In S840, the MFP 102 returns a response indicating that restart has been started.

In S841, the PWA receives the response in S840 and displays a screen indicating that restart of the MFP 102 has been started. FIG. 16C illustrates an example of the screen 1271 displayed in S841.

As described above, when details of an operation on setting values are received from the PWA, the MFP 102 according to the present embodiment reflects the setting change in the MFP 102 regardless of whether a setting screen is provided. Accordingly, the user can appropriately perform setting of the MFP 102 asynchronously regardless of the state of the MFP 102. Specifically, even when the MFP 102 is not powered on and thus the MFP 102 cannot provide a setting screen to the user terminal, the user 600 can opens the setting screen (the setting change screen) on the terminal 104 and perform a setting change operation (S804 and S805). When the MFP 102 is powered on, the PWA in the terminal 104 receives a push notification from the MFP 102 and automatically performs the setting change on the MFP 102 (S812 to S816). Accordingly, the user 600 does not need to open the setting change screen and to operate the settings after the MFP 102 has been powered on.

When restart of the MFP 102 is required for the setting change which is automatically performed, the terminal 104 can receive a notification indicating that requirement (S831). Accordingly, the user 600 can be prevented from losing restart required for completion of the setting change and restart the MFP immediately after the setting change has been performed.

After S841, the PWA may receive a push notification indicating that restart has been completed from the MFP 102 via the push server 103 and display the received notification on the terminal 104 via the web browser 500. Accordingly, the user 600 can be aware of the timing at which restart for reflection of the setting change has been completed (the setting change has been reflected).

### Second Embodiment

In the first embodiment, the MFP 102 notifies the terminal 104 that restart is required in the case of setting change requiring restart of the MFP. However, it is conceivable that the restart timing be delayed when the user overlooks the notification, and thus it may be wanted to automatically perform the restart. In some cases, it may be wanted to ascertain newest setting information and perform setting change at a timing at which the MFP is powered on. In a second embodiment, an operation of the PWA when a notification indicating that the MFP has been powered on is received from the MFP 102 can be set to flexibly cope with such cases. In the present embodiment, description of the same parts as in the first embodiment will be omitted, and only differences will be described.

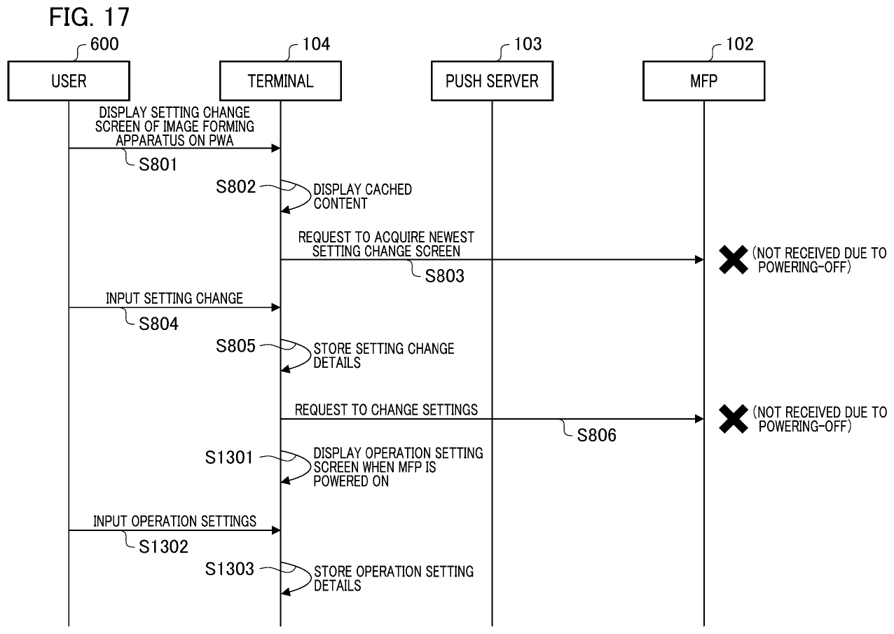

A sequence of processes in a case in which the user 600 changes settings of the MFP 102 via the PWA when the MFP 102 is powered off according to the second embodiment will be described below with reference to FIG. 17. Out of various processes illustrated in FIG. 17, the processes performed by the MFP 102 are realized by causing the CPU 201 of the MFP 102 to read a program of the software modules illustrated in FIG. 3 and stored in the storage device 204 to the RAM 203 and to execute the read program. Similarly, the processes performed by the push server 103 are realized by causing the CPU 201 of the push server 103 to read a program of the software modules illustrated in FIG. 4 and stored in the storage device 204 to the RAM 203 and to execute the read program. Similarly, the steps performed by the constituent devices of the terminal 104 are realized by causing the CPU 201 of the terminal 104 to read a program of the software modules illustrated in FIG. 5 and stored in the storage device 204 to the RAM 203 and to execute the read program.

FIG. 17 is a diagram illustrating a sequence until an operation setting screen 1411 when the MFP 102 is powered on which will be described later is displayed and an operation setting input on the screen is received according to the second embodiment. FIG. 17 is different from the first embodiment in that the processes of S1301 to S1303 are performed after S806 in FIG. 10. The difference will be described below.

In S1301, the PWA operating in the terminal 104 displays an operation setting screen when the MFP 102 is powered on. In the first embodiment, the PWA displays a message indicating that communication with the MFP 102 is not possible (S807). However, in the present embodiment, the operation setting screen is displayed such that the user can more specifically set the operation when the MFP 102 is powered on.

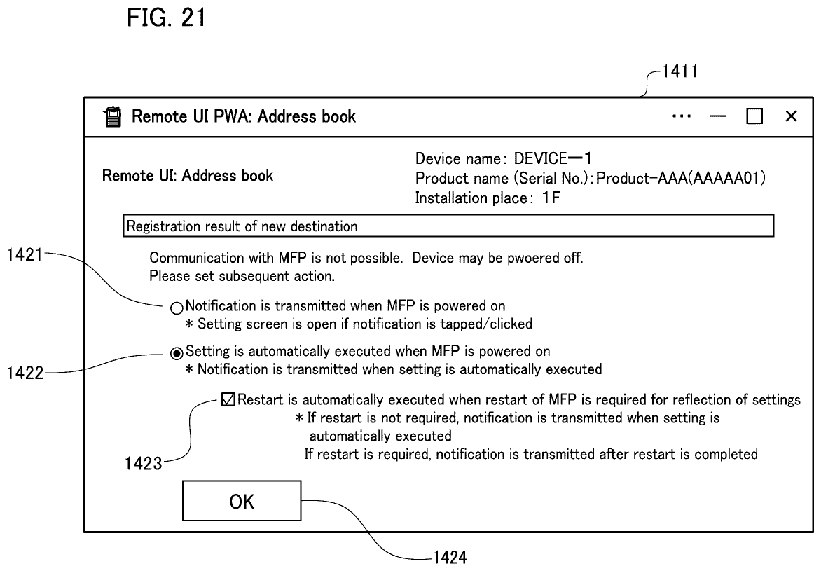

FIG. 21 illustrates an example of an operation setting screen 1411 when the MFP 102 is powered on which is displayed in S1301. In FIG. 21, an item 1421 is a selection item for displaying a notification indicating that the MFP 102 is powered on on the terminal 104 when the MFP 102 is powered on. An item 1422 is a selection item for automatically performing the setting change stored in S805 on the MFP 102 when the MFP 102 is powered on and displaying a notification indicating that the MFP 102 is powered on the terminal 104. An item 1423 is a check item which is checked when the item 1422 is selected, restart of the MFP 102 is required for reflection of the settings, and restart of the MFP 102 is automatically additionally performed. When the item 1421 is selected, the item 1423 is invalidated and thus turning-on/off of check cannot be performed. The item 1421 and the item 1422 employ a radio button format, and one thereof can be selected. An OK button 1424 is a button for confirming settings performed on the operation setting screen 1411 when the MFP is powered on.

In the present embodiment, the item 1422 is selected and check of the item 1423 is turned off as defaults of the operation setting screen 1411. This is settings for performing the same operation as in the first embodiment.

Setting patterns which can be set on the operation setting screen 1411 and operations of the PWA in each pattern are shown in Table 1. Details of the operation of the PWA in each pattern will be described later.

TABLE 1

| | | Check of | |
|---|---|---|---|
| Pattern | Selection | item 1423 | Operation of PWA |
| 1 | Item | — | Notification is transmitted when MFP is |
| | 1421 | | powered on. |
| 2 | Item | OFF | Setting is automatically performed and a |
| | 1422 | | notification is transmitted when MFP |
| | | | is powered on. |
| 3 | Item | ON | Setting is automatically performed |
| | | | when MFP is powered on, and |
| | 1422 | | notification is transmitted at |
| | | | the time of automatically performing |
| | | | setting when restart of MFP is not |
| | | | required for reflection of settings. |
| | | | Restart is automatically performed |
| | | | when restart of MFP is required for |
| | | | setting, and notification is transmitted |
| | | | when restart is completed. |

In S1302, the user 600 sets an operation when the MFP 102 is powered on the operation setting screen 1411 displayed in S1301 and presses the OK button 1424.

In S1303, the PWA stores setting details confirmed in S1302 in the data storage area 503.

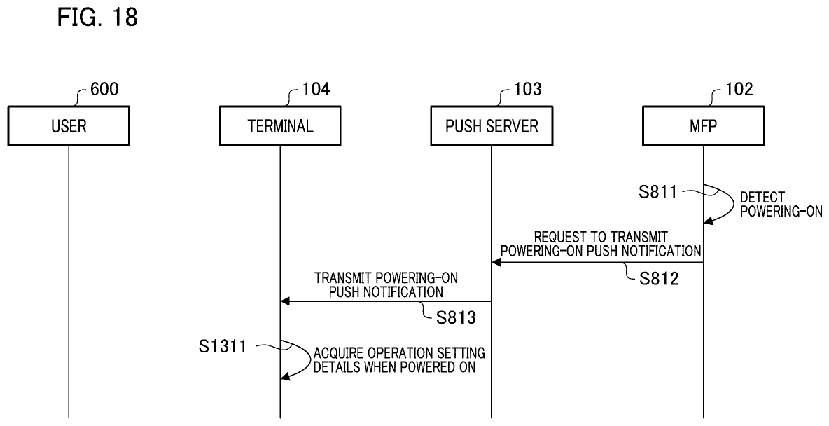

FIG. 18 is a diagram illustrating a sequence of processes when the MFP 102 is powered on after S1303. S811 to S813 in FIG. 18 are the same as S811 to S813 in FIG. 11, and thus description thereof will be omitted.

In S1311, when the push notification in S813 is received, the PWA operating in the terminal 104 acquires the operation setting details stored in the data storage area 503 in S1303. Then, the PWA performs a process corresponding to the acquired operation setting details.

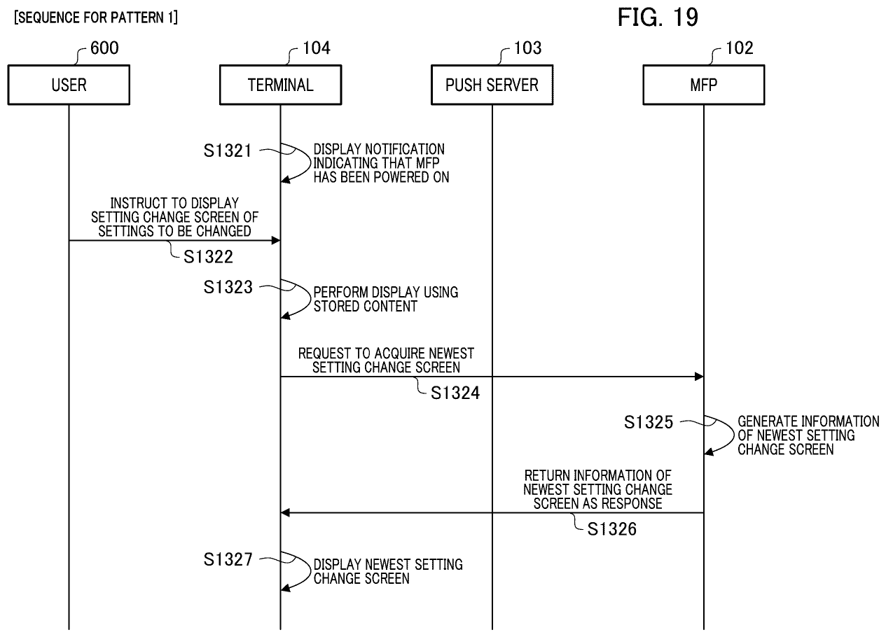

A sequence of processes when the operation setting details acquired in S1311 are pattern 1 will be described below with reference to FIG. 19.

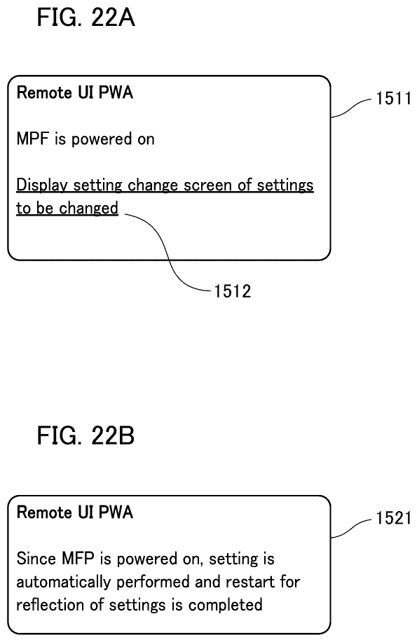

In S1321, the PWA operating in the terminal 104 displays a notification indicating that the MFP 102 is powered on the terminal 104 via the web browser 500. FIG. 22A illustrates an example of the notification 1511 which is displayed at that time. In the present embodiment, a link 1512 for displaying a setting change screen of settings to be changed is displayed in the notification 1511. This is because the user 600 who wants not to automatically perform the setting may ascertain newest setting details of the MFP 102 and change the setting change details according to necessity. In this case, it is possible to facilitate easily display of the setting change screen.

In S1322, for example, the user 600 presses the link 1512 in the notification displayed in S1321 and instructs the PWA to display the setting change screen of settings to be changed.

In S1323, similarly to S802, the PWA displays the setting change screen using information of content stored in the data storage area 503 before communicating with the MFP 102.

In S1324, similarly to S803, the PWA requests the MFP 102 to acquire the newest setting change screen.

In S1325, the remote UI request processing unit 301 of the MFP 102 acquires setting information or state information managed by the setting managing unit 305 or the state managing unit 303 of the MFP 102 according to necessity and generates information of the newest setting change screen.

In S1326, the remote UI request processing unit 301 of the MFP 102 returns information of the newest setting change screen generated in S1325 as a response to PWA.

In S1327, the PWA receives the response in S1326 and displays the newest setting change screen. Thereafter, the user 600 ascertains details of the screen and additionally performs setting change according to necessity.

A process when the operation setting details acquired in S1311 are pattern 2 is the same as the processes subsequent to S814 in FIG. 11 according to the first embodiment, and thus description thereof will be omitted.

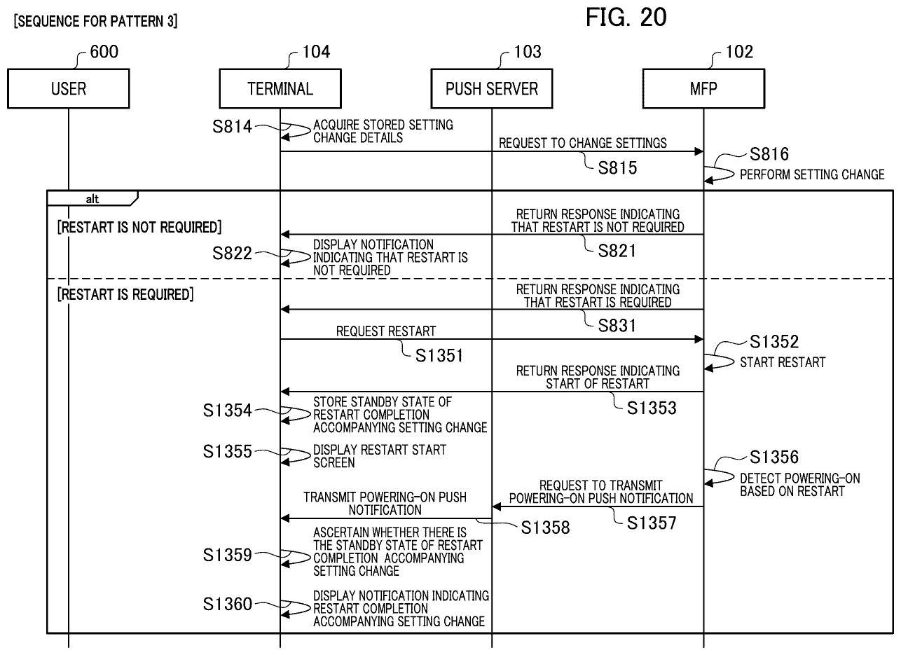

A sequence of processes when the operation setting details acquired in S1311 are pattern 3 will be described below with reference to FIG. 20.

S814 to S816 in FIG. 20 are the same as illustrated in FIG. 11 according to the first embodiment, and thus description thereof will be omitted. The same is true of S821 and S822 when restart is not required and S831 when restart is required. Processes subsequent S831 when restart is required will be described below.

In S1351, the PWA operating in the terminal 104 receives a response indicating that restart is required for completion of the setting change in S831 and requests the MFP 102 to restart.

In S1352, the remote UI request processing unit 301 of the MFP 102 requests the setting managing unit 305 to restart the MFP 102, and the setting managing unit 305 starts restart of the MFP 102.

In S1353, the remote UI request processing unit 301 of the MFP 102 returns a response indicating that restart has been started to the PWA.

In S1354, the PWA stores information indicating standby state of a restart completion accompanying the setting change in the data storage area 503.

In S1355, the PWA displays a screen 1271 (FIG. 16C) indicating that restart of the MFP 102 has been started similarly to S841.

In S1356, the event managing unit 304 of the MFP 102 detects that the MFP 102 has been powered on by the restart performed in S1352 as an event in the MFP 102 and requests the notification transmitting unit 302 to transmit a push notification of the powering-on event.

In S1357, the notification transmitting unit 302 of the MFP 102 transmits a push notification request for notifying a registered notification target that the MFP 102 has been powered on to the push server 103 similarly to S812.

In S1358, similarly to S813, the request receiving unit 403 of the push server 103 receives the push notification request in S1357 and sends the details thereof to the notification transmitting unit 406. The notification transmitting unit 406 transmits a push notification indicating that the MFP 102 has been powered on to the terminal 104 to be notified on the basis of information included in the sent push notification request.

In S1359, the PWA operating in the terminal 104 ascertains whether information indicating the standby state of the restart completion accompanying the setting change is stored in the data storage area 503. In the present embodiment, it is assumed that information indicating the standby state of the restart completion accompanying the setting change is stored in the terminal 104 in S1354.

In S1360, the PWA displays a notification. The notification indicates that the setting change received in S804 has been performed on the MFP 102 and indicates that restart of the MFP 102 for reflection of the setting change has been completed. FIG. 22B illustrates the notification 1521 which is displayed at that time.

As described above, in the present embodiment, the operation of the PWA when the push notification (S813) indicating powering-on is acquired from the MFP 102 (S1311) can be set (S1301 to S1303). Accordingly, this system 100 can flexibly cope with a case in which it is wanted to automatically perform restart of the MFP 102 for reflection of the setting change, a case in which it is wanted to ascertain the newest setting information at the timing at which the MFP 102 has been powered on and to perform the setting change, and the like.

When setting of pattern 1 in Table 1 is performed in S1302 in FIG. 17, the setting change details stored in S805 may be discarded. This is because the newest setting change screen is acquired after S1324 in pattern 1 as illustrated in FIG. 19. In this case, the link 1512 may not be displayed in the notification 1511 in FIG. 22A.

### Third Embodiment

The service worker of the PWA in the first embodiment can receive a push notification indicating that the MFP 102 has been powered on by causing the service worker processing unit 502 of the web browser 500 to operate. However, there is a likelihood that the web browser 500 of the terminal 104 is stopped due to some factors and the service worker is stopped. In this case, it is conceivable that the PWA do not receive a push notification indicating that the MFP 102 has been powered on and be not able to automatically perform the setting change received in S804. The PWA in a third embodiment is caused to perform the setting change received in S804 even in this case. In the present embodiment, description of the same parts as in the first embodiment will be omitted, and only differences will be described.

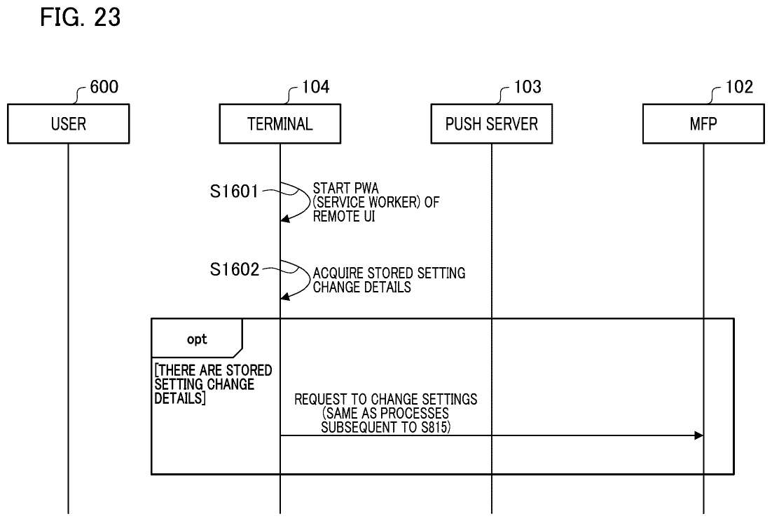

FIG. 23 is a diagram illustrating a sequence of processes when the web browser 500 having stopped starts in the terminal 104. Out of various processes illustrated in FIG. 23, the steps performed by the constituent devices of the terminal 104 are realized by causing the CPU 201 of the terminal 104 to read a program of the software modules illustrated in FIG. 5 and stored in the storage device 204 to the RAM 203 and to execute the read program.

In S1601, the PWA starts with starting of the web browser 500 of the terminal 104. Starting of the web browser 500 is performed, for example, with restart of the terminal 104 or an instruction for starting the web browser 500 or the PWA from the user 600 as a trigger.

In S1602, the PWA acquires the setting change details for the MFP 102 stored in the data storage area 503. At this time, the PWA ends this sequence when the acquired setting change details are empty (the setting change details are not stored). When the stored setting change details are acquired, the PWA performs processes subsequent to S815 illustrated in FIG. 11.

Accordingly, even when a push notification indicating that the MFP 102 has been powered on cannot be received while the web browser 500 has stopped, the PWA can automatically perform the stored setting change on the MFP 102 at the timing of starting thereof.

### Fourth Embodiment

There is a likelihood that the PWA in the first embodiment will not be able to perform the setting change due to a defect of a communication path with the MFP 102 in addition to the reason the MFP 102 is powered off. The PWA in a fourth embodiment is caused to automatically perform the setting change when communication with the MFP 102 becomes possible in this case. In the present embodiment, description of the same parts as in the first embodiment will be omitted, and only differences will be described.

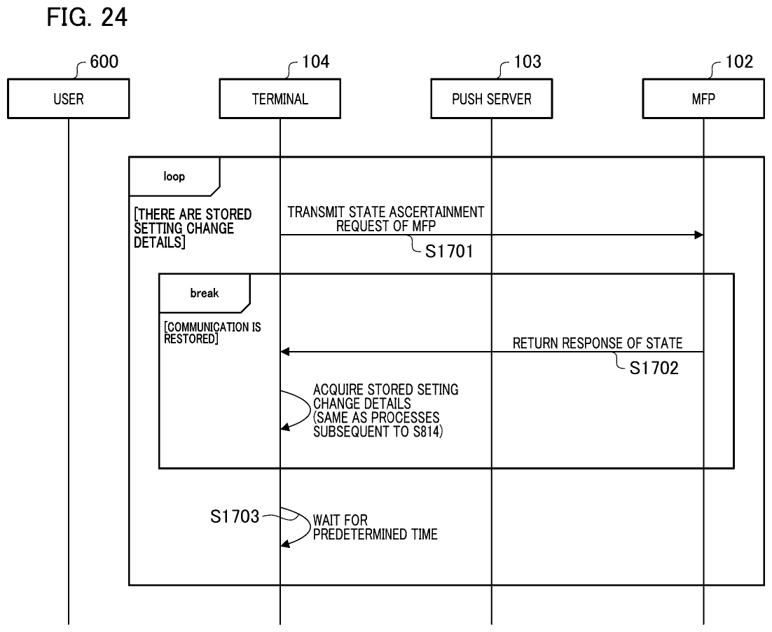

FIG. 24 is a diagram illustrating a sequence of processes when communication with the MFP 102 is not possible in S806 illustrated in FIG. 10 according to the first embodiment. As such a case in which communication with the MFP 102 is not possible, a case in which the MFP 102 is powered off, a case in which a communication path between the terminal 104 and the MFP 102 has a defect, and the like are conceivable.

Out of various processes illustrated in FIG. 24, the processes performed by the MFP 102 are realized by causing the CPU 201 of the MFP 102 to read a program of the software modules illustrated in FIG. 3 and stored in the storage device 204 to the RAM 203 and to execute the read program. Similarly, the steps performed by the constituent devices of the terminal 104 are realized by causing the CPU 201 of the terminal 104 to read a program of the software modules illustrated in FIG. 5 and stored in the storage device 204 to the RAM 203 and to execute the read program.

It is assumed that S1701 and S1703 described below are repeatedly performed when setting change details for the MFP 102 are stored in the data storage area 503.

In S1701, the PWA operating in the terminal 104 transmits a state ascertainment request to the MFP 102.

In S1702, when communication with the MFP 102 is restored and the state ascertainment request in S1701 is received, the remote UI request processing unit 301 of the MFP 102 returns a response indicating that reception. When this response has been returned, the processes subsequent to S814 in FIG. 11 are performed and excluded from the repeated processes.

In S1703, when communication with the MFP 102 is not restored, the PWA waits for a predetermined time and repeatedly performs the process of S1701.

Accordingly, even when communication with the MFP 102 is not possible as well as when the MFP 102 is powered off, the PWA can automatically perform the stored setting change on the MFP 102 at the timing at which communication with the MFP 102 is restored.

### OTHER EMBODIMENTS

At least two embodiments of the first, second, third, and fourth embodiments may be combined. For example, in the third embodiment, when the stored setting change details are acquired after S1602, the PWA performs the processes subsequent to S815 in FIG. 11 (the first embodiment), but may perform the processes subsequent to S815 in FIG. 20 (the second embodiment). In the fourth embodiment, similarly, when a response indicating that the state ascertainment request in S1701 has been received is transmitted, the PWA performs the processes subsequent to S814 in FIG. 11 (the first embodiment), but may perform the processes subsequent to S814 in FIG. 20 (the second embodiment).

In the aforementioned embodiments, an MFP is described as an example of a network device, but a device including a web server and capable of providing a remote UI such as a network router, a monitoring camera, or a digital medical device can be used.

In the aforementioned embodiments, the push server 103 and the MFP 102 are different devices, but the MFP 102 may include a push server.

Embodiments of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application-specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-151355, filed Sep. 3, 2024, which is hereby incorporated by reference wherein in its entirety.

What is claimed is:

1. A network device including a web server, the network device comprising:
a memory storing instructions; and
a processor executing the stored instructions causing the network device to:
provide a web browser with a setting screen for operating setting values of a plurality of setting items for the network device via a network using the web server; and
reflect the setting values in the network device in response to an operation of the setting values,
wherein a web site for installing software that is a progressive web app for providing a function of operating setting values of at least one setting item among the plurality of setting items in a user terminal is provided by the web server, and
wherein at least one setting value is reflected in the network device in response to reception of detail of the operation of at least one of the setting values performed using the progressive web app from the user terminal via the network regardless of whether the setting screen has been provided by the network device.

2. The network device according to claim 1, wherein execution of the stored instructions by the processor further causes the network device to transmit a push notification corresponding to an event that occurs in the network device to the user terminal via the network.

3. The network device according to claim 2, wherein a notification that indicates whether the network device is to be restarted for reflecting the setting value is transmitted as the push notification.

4. The network device according to claim 3, wherein execution of the stored instructions by the processor further causes the network device to start a restarting process in response to reception of a request for restart of the network device based on the notification from the user terminal via the network.

5. The network device according to claim 2, wherein a notification indicating that the network device is powered on is transmitted when the network device is powered on, and
wherein the setting value is reflected in the network device in response to reception of detail of the operation of the setting value from the user terminal via the network after the notification indicating the network device is powered on has been transmitted.

6. The network device according to claim 2, wherein execution of the stored instructions by the processor further causes the network device to provide an operation setting screen for receiving settings of an operation when the network device is powered on using software of the progressive web app.

7. The network device according to claim 6, wherein the operation setting screen includes an item for receiving an instruction to automatically perform restarting of the network device for reflecting the setting value.

8. The network device according to claim 6, wherein a newest setting screen is provided via the network in response to reception of a request for acquiring the newest setting screen from the user terminal via the network.

9. The network device according to claim 6, wherein execution of the stored instructions by the processor further causes the network device to:
start a restarting process in response to reception of a request for restarting the network device based on the push notification from the user terminal via the network; and
transmit a notification indicating that the network device has been restarted to the user terminal.

10. The network device according to claim 2, wherein, when a notification indicating that the network device is powered on is transmitted as the push notification while software of the progressive web app of the user terminal has stopped, the setting value is reflected in the network device in response to reception of detail of an operation of the setting value after the software of the progressive web app of the user terminal has been started.

11. The network device according to claim 1, wherein, when communication between the network device and the user terminal has become impossible due to a reason other than a reason the network device is powered off, the setting value is reflected in the network device in response to the communication becoming possible and detail of an operation of the setting value being received from the user terminal via the network.

12. The network device according to claim 1, wherein the network device is an image processing apparatus including a scanner or a printer.

13. The network device according to claim 12, wherein the plurality of setting items are included in settings that relate to an environment or an application of the image processing apparatus.

14. A method for a network device including a web server, the method comprising:
providing a web browser with a setting screen for operating setting values of a plurality of setting items for the network device via a network using the web server; and
reflecting the setting values in the network device in response to an operation of the setting values,
wherein the providing of the setting screen includes providing a web site for installing software that is a progressive web app for providing a function of operating setting values of at least one setting item among the plurality of setting items in a user terminal by the web server, and
wherein the reflecting of the setting values includes reflecting at least one setting value in the network device in response to reception of detail of the operation of at least one of the setting values performed using the progressive web app from the user terminal via the network regardless of whether the setting screen has been provided by the network device.

15. A non-transitory storage medium storing a program of a network device including a web server, the program causing a computer to perform each step of a method for the network device, the method comprising:
providing a web browser with a setting screen for operating setting values of a plurality of setting items for the network device via a network using the web server; and
reflecting the setting values in the network device in response to an operation of the setting values,
wherein the providing of the setting screen includes providing a web site for installing software that is a progressive web app for providing a function of operating setting values of at least one setting item among the plurality of setting items in a user terminal by the web server, and
wherein the reflecting of the setting values includes reflecting at least one setting value in the network device in response to reception of detail of the operation of at least one of the setting values performed using the progressive web app from the user terminal via the network regardless of whether the setting screen has been provided by the network device.
